(19) United States
(12) Patent Application Publication
(10) Pub. No.: US 2024/0394587 A1
(43) Pub. Date: Nov. 28, 2024

(54) CUSTOM CLUSTERING ON NETWORK AND APPLICATION DATA FOR ANOMALY DETECTION

(71) Applicant: WatchGuard Technologies, Inc., Seattle, WA (US)

(72) Inventors: Anindya ROY, Littleton, MA (US); Eugen PANAITESCU, Brookline, MA (US); Li LI, Acton, MA (US); Ramesh NATARAJAN, Lincoln, MA (US)

(21) Appl. No.: 18/292,748

(22) PCT Filed: Jul. 27, 2022
(86) PCT No.: PCT/US22/38595

§ 371 Date: Jan. 26, 2024

Related U.S. Application Data
(60) Provisional application No. 63/226,923, filed on Jul. 29, 2021.

(51) Int. Cl. G06N 20/00; G06N 7/01

(52) U.S. Cl. CPC G06N 20/00; G06N 7/01

(57) ABSTRACT

A computer-implemented system and method generate a model of a plurality of features of network flow data. The model includes a composition of a plurality of Gaussian components, each of which may be skewed. The features are represented as a multivariate feature vector. Training is performed on the feature data using Gaussian Mixture Model (GMM) using Expectation Maximization. The feature data are assigned to clusters with corresponding probabilities. Once the model has been generated, it may be used to detect outlier activity.

### BACKGROUND

Communication networks face an increasing variety of increasingly-sophisticated and evolving threats. A variety of techniques exist for identifying such threats by establishing a baseline of healthy network activity and then identifying unhealthy activity by comparing ongoing activity relative to the baseline. Such existing techniques, however, have a variety of limitations which result in high false positives or false negatives. What is needed, therefore, are improved techniques for automatically identifying unhealthy network activity on an ongoing basis.

### SUMMARY

A computer-implemented system and method generate a model of a plurality of features of observed network-related data (e.g., network flow data, user activity logs, and/or VPN logs). The model includes a probabilistic convolution of a plurality of Gaussian components, each of which may be skewed. The features are normalized and represented together as a multivariate m-feature vector. Training of the model involves estimating the data as the convolution of Gaussian components. The underlying Gaussian components are estimated using Gaussian Mixture Model (GMM), which uses the Expectation Maximization (EM) algorithm. After the model is trained and learning is complete, new data are mapped to the trained clusters with soft probabilities. New data are examined for being an outlier using an adjusted z_score, which uses a novel sigma that is robust against data poisoning and takes into account the skewness of the cluster's individual Gaussian component.

Other features and advantages of various aspects and embodiments of the present invention will become apparent from the following description and from the claims.

### BRIEF DESCRIPTION OF THE DRAWINGS

FIG. 1 is a dataflow diagram of a system for determining whether a multivariate feature vector represents an anomaly according to one embodiment of the present invention;

FIG. 2 is a flowchart is shown of a method performed by the system of FIG. 1 according to one embodiment of the present invention;

FIG. 3A is a graph of user login activity distribution data according to one embodiment of the present invention;

FIG. 3B is a graph illustrating modeling the user login activity distribution data of FIG. 3A as a mixture of several Gaussian components according to one embodiment of the present invention; and

FIG. 4 is an illustration of a skewed Gaussian component according to one embodiment of the present invention.

### DETAILED DESCRIPTION

As mentioned above, communication networks face an increasing variety of increasingly-sophisticated and evolving threats. Embodiments of the present invention are directed to improved techniques for automatically identifying unusual activity, which might be malicious, on an ongoing basis. In particular, embodiments of the present invention may be used to detect unusual patterns of access by users to a resource (e.g., computer system and/or network). For example, embodiments of the present invention may be used to model and detect anomalous accesses by a user (or attempts to access by a user) to a resource via a Virtual Private Network (VPN), via Remote Desktop Protocol (RDP), or via any kind of Software as a Service (SaaS) mechanism. One example of a user access is a user login to a resource. Examples of resources include computers, networks, devices, and applications.

As will be described in more detail below, embodiments of the present invention may detect, monitor, and record features of a plurality of such user accesses (which may included both successful accesses and/or attempts at access) over a defined period of time, thereby generating data representing a baseline of normal user accesses (referred to herein as “baseline data”). The features that may be detected, monitored, and recorded may, for example, include the geolocation of the access (e.g., latitude and/or longitude) and/or the time of the access (e.g., time epoch and/or day). The set of features that is used is referred to herein as a “feature set.” Although geolocation and time are used herein as examples of a feature set, these are merely examples and do not constitute limitations of the present invention. In general, embodiments of the present invention may normalize the features and represent them together as a multivariate m-feature vector. Each data point in the baseline data, therefore, is m-dimensional. The set of baseline data on a given time window therefore produce a shape in m dimensions. This shape of the baseline data is unpredictable and may not resemble a particular shape or size.

In practice, the baseline data may not be susceptible to being modeled accurately using a single standard Gaussian distribution with low false positives. For example, the baseline data may be multimodal. As another example, the baseline data may be skewed relative to a standard Gaussian distribution. In order to address the problems that can result from attempting to model the baseline data using a single standard Gaussian distribution, embodiments of the present invention may generate a model of the baseline data using a convolution of a plurality of Gaussian components (each of which may be skewed), such that each data point in the baseline data belongs to each of the plurality of Gaussian components with a corresponding probability.

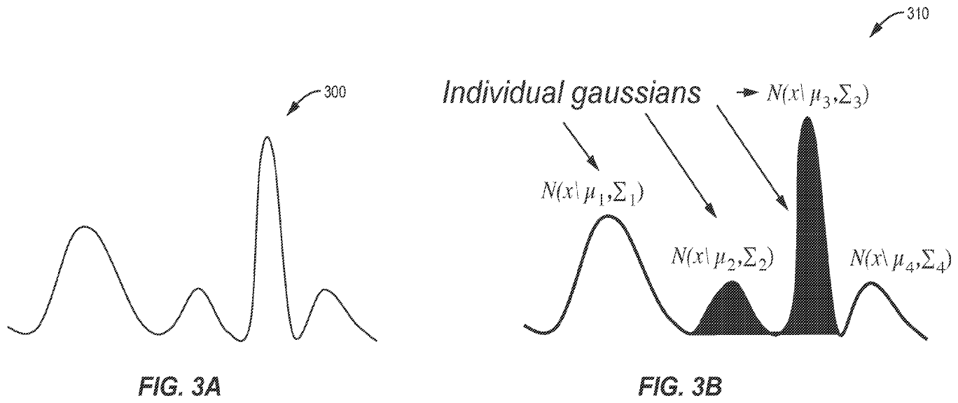

For example, referring to FIG. 3A, an example of user login activity distribution data 300 is shown according to one embodiment of the present invention. In the example of FIG. 3A, the data 300 are multi-modal, and thus do not match any single parametric statistical model. FIG. 3B illustrates a model 310 of the data 300, which models the data 300 as a convolution of a plurality of Gaussian components in order to model the multi-modal shape of the data 300. Although the example model shown in FIG. 3B includes a composition of four distinct Gaussian components, models generated by embodiments of the present invention may include a composition of any number of distinct Gaussian components.

In particular, the feature data distribution p(x) of the data 300 may be estimated as a joint probability distribution of the individual Gaussian components. Feature data within the baseline data may be assigned to one or more clusters with a corresponding probability, using log likelihood: log p (data|cluster). More specifically, the feature Data distribution p(x) may be estimated as a Joint Probability Distribution of the individual gaussian components, e.g.:

$$p ( x ) = {\sum }_{k = 1}^{K} {π}_{k} k N ( x \vert {μ}_{k} , {Σ}_{k} ) ,$$

where the πₖ's are the mixing weights, such that:

$${\sum }_{k = 1}^{K} {π}_{k} = 1 , {π}_{k} \geq 0$$

The distribution may be estimated as a weighted sum, where πₖ is the proportion of data generated by the kₜₕ distribution.

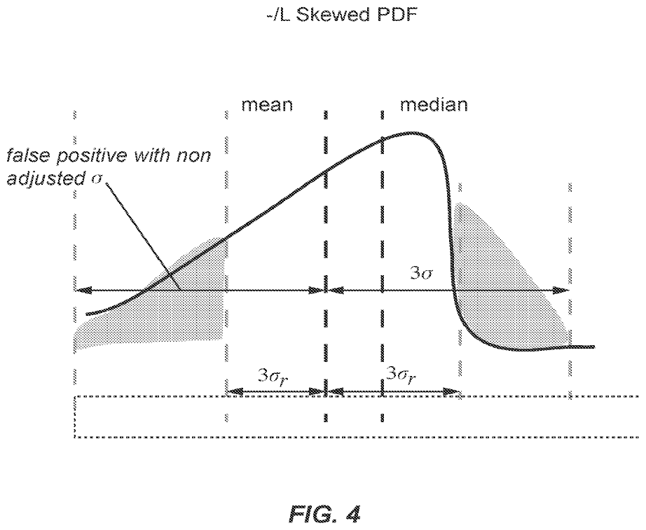

Embodiments of the present invention may map the multivariate data space to the plurality of Gaussian components, where any one or more (e.g., all) of those components may be skewed to better account for the data. An example of such a skewed Gaussian component is shown in FIG. 4. Embodiments of the present invention may use a novel sigma σᵣ to take skewness of the distribution into account, which may be calculated as:

$$( {σ}_{r} ) = 1 / 3 ( {σ}_{1} + {σ}_{2} + ( {σ}_{3} )$$

where σ₁=1.4826*MAD, σ₂=1.4826*(Q₃−Q₁)/2 where Q₁ and Q₃ are first and third quartile, σ3=σ+skewness.

The above is merely one example of a sigma σᵣ that may be used by embodiments of the present invention. Embodiments of the present invention may use methods (e.g., formulas) to produce the value of sigma σᵣ. For example, embodiments of the present invention may use a sigma σᵣ which, like the sigma σᵣ above, is a combination (e.g., weighted combination) of a plurality of components. Each of the plurality of components may be a value that is based on the distribution in some way, and each of the plurality of components may differ from each other. The particular components and method of combining the components (including the weightings, in the case of a weighted combination) to produce the value of sigma Jr may vary. In this particular example above:
The first component σ₁ is the Median Absolute Deviation (MAD) multiplied by a constant. In this example, the constant is chosen to produce an approximation to the standard deviation of the distribution.
The second component σ₂ is based on the difference between the first and third quartiles of the distribution. More specifically, the second component σ₂ approximates an average of the first and third quartiles.
The third component σ₃ is the conventional standard deviation of the distribution, adjusted based on the skewness value.

This mapping may assign, to each data point within each of the Gaussian components, a corresponding probability that the access falls within the distribution represented by that component. This process of making probabilistic assignments of data points to Gaussian components effectively assigns those data points to a plurality of overlapping clusters, and is referred to as “soft clustering.” Each cluster may be modeled using a multivariated Gaussian distribution whose model parameters are estimated using expectation maximization.

Such soft clustering may be performed using Gaussian Mixture Modeling (GMM) with Expectation Maximization. Soft clustering performed by embodiments of the present invention is significantly different from, and advantageous over, hard clustering. For example, K means clustering assumes that the data falls into circular shape partitions, and therefore is not able to make fractional assignments of data to clusters, unlike embodiments of the present invention. Furthermore, embodiments of the present invention may take into account skewness in the baseline data by using a novel robust adjusted deviation metric to fine tune the model to better fit the underlying skewed data.

Embodiments of the present invention may learn the model based on all of the features in the feature set simultaneously in a multivariate model. Using a multivariate model addresses the problem of false positives that can result from learning based only on a single feature, or based on each of a plurality of features separately. More specifically, features that are independent of each other may be selected as candidates for defining the multivariate feature space. Thus, for an m-dimensional data point to not belong to a cluster would mean that data is a outlier across multiple feature dimensions with some probability, thereby boosting its overall likelihood to be a true positive.

Once the model has been learned, embodiments of the present invention may use the model to detect anomalous user accesses. For example, embodiments of the present invention may detect an access and use the model to assign, to each of the plurality of modes in the model, a probability that the access falls within that mode. In this way, embodiments of the present invention may be used to predict anomalous user accesses.

Although embodiments of the present invention have been described herein as being applied to user accesses, this is merely an example and does not constitute a limitation of the present invention. More generally, embodiments of the present invention may be used to generate a model of any action taken in connection with a computer network resource, and then to predict whether a subsequent action taken in connection with the computer network resource is anomalous. For example, a VPN or cloud access may happen from any part of the world, and the cloud provider may not have the baseline reference required to identify unusual login access made to the cloud. Embodiments of the present invention may be used to identify unusual access in this situation based on, for example, time, day of the week, and geolocation, where these features together form a multivariate feature space.

As another example, embodiments of the present invention may detect DNS tunneling with reduced false positives by combining multiple DNS detection features in a multivariate space and then applying the robust soft clustering disclosed elsewhere herein. For example the features in the multivariate feature vectors (e.g., in the multivariate feature data 102 used to train the model 110, and in the new multivariate feature vector) may include:
In the case of detecting a slow tunnel: (1) flows; (2) flows/duration; and (3) total flow duration.
In the case of detecting a fast tunnel: (1) bytes/flow; and (2) packets/flow.

Having described embodiments of the present invention at a high level, specific embodiments of the present invention will now be described in more detail.

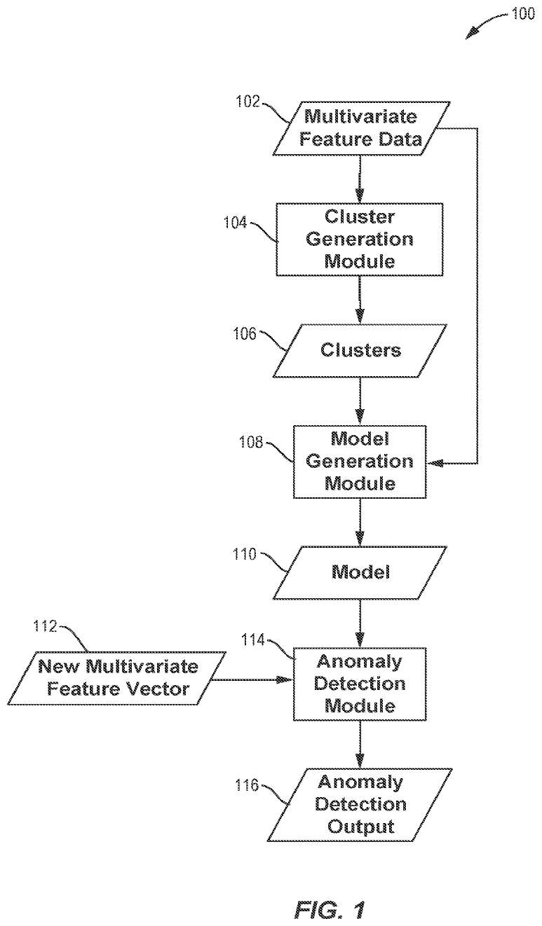

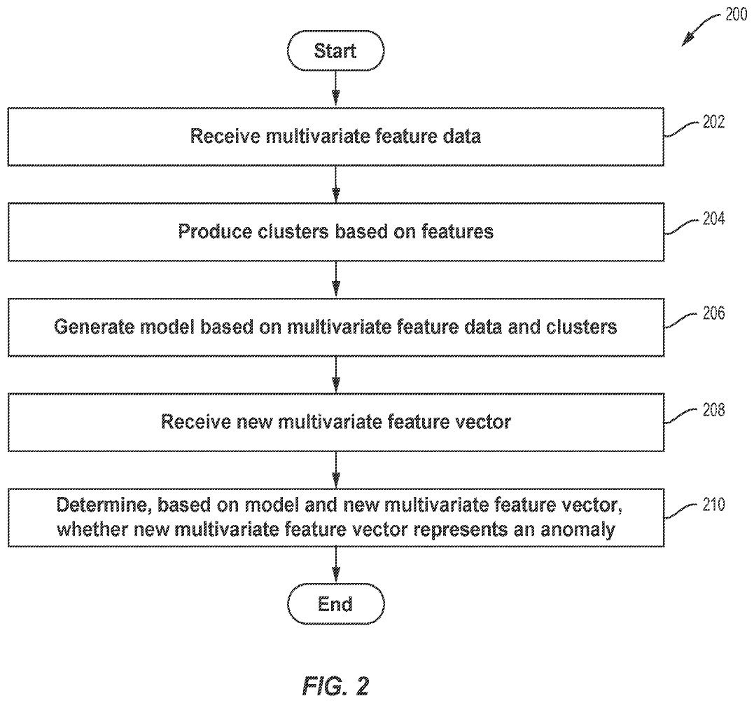

Referring to FIG. 1, a dataflow diagram is shown of a system 100 for determining whether a multivariate feature vector represents an anomaly according to one embodiment of the present invention. Referring to FIG. 2, a flowchart is shown of a method 200 performed by the system 100 of FIG. 1 according to one embodiment of the present invention.

The system 100 includes multivariate feature data 102, which may include a plurality of multivariate feature vectors, each of which may include a corresponding plurality of values of a plurality of features. There may be any number of multivariate feature vectors and any number of features. The value of each feature may vary or be the same from vector to vector, in any combination.

The multivariate feature data 102 may, before the method 200, be generated in any of a variety of ways. For example, the multivariate feature data 102 may, before operation of the system 100 and method 200, be generated based on user login access data. For each of the plurality of multivariate feature vectors in the multivariate feature data 102 may be generated based on, and represent features of, user login access data representing a corresponding plurality of user login access attempts. The system 100 and method 200 do not require the multivariate feature data 102 to have been generated in any particular way. The user login access data may include for example, a plurality of network flow logs and/or a plurality of application logs. Generating the multivariate feature data 102 may include selecting a plurality of features from network flow logs and/or application logs to create the plurality of multivariate feature vectors, having values of the plurality of selected features, within the multivariate feature data.

The system 100 may include a cluster generation module 104, which may receive the multivariate feature data 102 (and hence the plurality of multivariate feature vectors within the multivariate feature data 102) as input (FIG. 2, operation 202). The cluster generation module 104 may produce a plurality of clusters 106 based on the plurality of features (FIG. 2, operation 204). Although there may be any number of clusters 106, in some embodiments the number of the plurality of clusters 106 is equal to the number of the plurality of features. Embodiments of the present invention may select the number of clusters 106 in any of a variety of ways, such as by using sieving, which involves iterating to find an optimal number of clusters 106.

Generating the clusters 106 may include clustering the plurality of features using Expectation Maximization of a Gaussian Mixture Model (GMM). Generating the clusters 106 may include assigning, to each of the plurality of clusters, a corresponding skew to account for skew in the plurality of multivariate feature vectors in the multivariate feature data 102.

The system 100 may include a model generation module 108, which may generate, based on the clusters 106 and the multivariate feature data 102, a model 110 for determining whether new multivariate feature vectors represent anomalies (FIG. 2, operation 206). As will be described in more detail below, generating the model 110 may include, among other things, assigning, for each multivariate feature vector V in the multivariate feature data 102, and for each cluster C in the plurality of clusters 106, a probability that vector V is within cluster C. Assigning such a probability may, for example, be performed using log likelihood, e.g.:

log p(data|cluster)

Producing the model 110 (which may be a multivariate model) may include learning the model 110 based on the plurality of features simultaneously. Producing the model 110 may include learning the model based on the plurality of multivariate feature vectors in the multivariate feature data 102.

The model 110 may include a composition of a plurality of Gaussian distributions. The plurality of Gaussian distributions may include a convolution of the plurality of Gaussian distributions. Each of the plurality of Gaussian distributions may correspond to a distinct one of the plurality of clusters 106 (i.e., there may be a one-to-one correspondence between the plurality of Gaussian distributions and the plurality of clusters 106).

The system 100 may include an anomaly detection module 114, which may receive, as input, the model 110 and a new multivariate feature vector 112 (i.e., a multivariate feature vector 112 that is not among the plurality of multivariate feature vectors in the multivariate feature data 102) (FIG. 2, operation 208). The new multivariate feature vector 112 may include the same features as the multivariate feature vectors in the multivariate feature data 102.

The anomaly detection module 114 may determine, based on the model 110 and the new multivariate feature vector 112, whether the new multivariate feature vector 112 represents an anomaly (FIG. 2, operation 210). The anomaly detection module 114 may generate anomaly detection output 116 indicating whether, according to the anomaly detection module 114's determination, the anomaly detection module 114 represents an anomaly.

The anomaly detection module 114 may determine whether the new multivariate feature vector represents any of a variety of kinds of anomalies. For example, the system 100 may detect an attempt by a user to login to a computer system (e.g., hardware, software application, or a combination thereof), referred to herein as a “user login access attempt,” and generate the new multivariate feature vector to represent a plurality of features of the user login access attempt. In this example, the anomaly detection module may, in operation 210, determine, based on the model 110 and the new multivariate feature vector 112, whether the user login access attempt is an anomaly.

The plurality of features may, for example, include one or both of the following: a geolocation (e.g., latitude and/or longitude) of the user login access attempt and a time (e.g., day and/or time epoch) of the user login access attempt. In some embodiments, the plurality of features includes (e.g., consists of) a latitude, longitude, day, and time epoch of the user login access attempt.

Another example of a kind of anomaly that the anomaly detection module may detect is a DNS tunnel, in which case, the plurality of features may include:
In the case of detecting a slow tunnel: flows, flows/duration, and total flow duration.
In the case of detecting a fast tunnel: bytes/flow and packets/flow The plurality of features may, for example, include a slow DNS tunnel feature and/or a fast DNS tunnel feature.

Determining whether the new multivariate feature vector 112 represents an anomaly (FIG. 2, operation 210) may include, for example: identifying, for each of the plurality of clusters 106, a percentage likelihood that the multivariate feature vector 112 falls within that cluster; and determining that the multivariate feature vector 112 represents an anomaly if the multivariate feature vector 112 does not fall within any of the plurality of clusters 106.

Such anomaly detection may be performed using adjusted z-scores assigned to each multi-variate vector to evaluate if that vector is outside its assigned set of clusters. Such adjusted z-scores may be calculated based on the novel sigma described above, which takes the skewness of the distribution into account.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention ingest and analyze network received over a telecommunications network. Such a function cannot be performed mentally or manually. For example, embodiments of the present invention may ingest volumes of such data in time periods that would be impossible to perform mentally or manually. For example, embodiments of the present invention may ingest thousands of data points and analyze those data points to identify and assign a state to a service in under 1 second, in under 10 seconds, or in under 60 seconds, and may do so repeatedly (e.g., continuously). Such a function would be impossible for a human to perform mentally or manually. More generally, embodiments of the present invention are inherently rooted in network communication technology and constitute improvements to such technology.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

What is claimed is:

1. A method performed by at least one computer processor executing computer program instructions stored on at least one non-transitory computer-readable medium, the method comprising:
(A) receiving multivariate feature data,
the multivariate feature data comprising a plurality of multivariate feature vectors,
wherein each of the multivariate feature vectors comprises a corresponding plurality of values of a plurality of features;
(B) producing a plurality of clusters based on the multivariate feature data; and
(C) assigning, for each the multivariate feature vectors V and for each of the plurality of clusters C, a probability that vector V is within cluster C,
wherein the assigning comprises assigning, to each of the plurality of clusters, a corresponding skew to account for skew in the plurality of multivariate feature vectors.

2. The method of claim 1, wherein clustering the plurality of features comprises clustering the plurality of features using Expectation Maximization of a Gaussian Mixture Model (GMM).

3. The method of claim 1, wherein the number of the plurality of clusters is equal to the number of the plurality of features.

4. The method of claim 1, wherein (C) comprises learning a multivariate model based on the plurality of features simultaneously.

5. The method of claim 1, wherein learning the multivariate model comprises learning the multivariate model based on the plurality of multivariate feature vectors.

6. The method of claim 4, wherein the multivariate model comprises a composition of a plurality of Gaussian distributions.

7. The method of claim 6, wherein the composition of the plurality of Gaussian distributions comprises a convolution of the plurality of Gaussian distributions.

8. The method of claim 6, wherein each of the plurality of Gaussian distributions corresponds to a distinct one of the plurality of clusters.

9. The method of claim 1, further comprising, after (A), (B), and (C):
(D) receiving a new multivariate feature vector that was not within the multivariate feature data; and
(E) determining, based on the learned model and the new multivariate feature vector, whether the new multivariate feature vector represents an anomaly.

10. The method of claim 9:
wherein (D) comprises:
(D)(1) detecting a user login access attempt; and
(D)(2) generating the new multivariate feature vector to represent a plurality of features of the user login access attempt; and
wherein (E) comprises determining, based on the learned model and the new multivariate feature vector, whether the user login access attempt is an anomaly.

11. The method of claim 10, wherein the plurality of features includes a geolocation of the user login access attempt and a time of the user login access attempt.

12. The method of claim 11, wherein the geolocation of the user login access attempt comprises a latitude of the user login access attempt and a longitude of the user login access attempt, and wherein the time of the user login access attempt comprises a day of the user login access attempt and a time epoch of the user login access attempt.

13. The method of claim 9, wherein (E) comprises:
(E)(1) identifying, for each of the plurality of clusters in the learned model, a percentage likelihood that the new multivariate feature vector falls within that cluster; and
(E)(2) determining that the new multivariate feature vector is an anomaly if the new multivariate feature vector is determined not to fall within any of the plurality of clusters.

14. The method of claim 1, wherein the plurality of features includes geolocation and access time of an attempted user login access attempt.

15. The method of claim 14, wherein geolocation includes latitude and longitude.

16. The method of claim 14, wherein access time includes time epoch and day.

17. The method of claim 1, wherein the plurality of features includes a slow DNS tunnel feature.

18. The method of claim 1, wherein the plurality of features includes a fast DNS tunnel feature.

19. The method of claim 1, further comprising, before (A):
generating the multivariate feature data based on user login access data.

20. The method of claim 19, wherein the user login access data comprises a plurality of network flow logs.

21. The method of claim 19, wherein the user login access data comprises a plurality of application logs.

22. A system comprising at least one non-transitory computer-readable medium having computer program instructions stored thereon, the computer program instructions being executable by at least one computer processor to perform a method, the method comprising:
(A) receiving multivariate feature data,
the multivariate feature data comprising a plurality of multivariate feature vectors,
wherein each of the multivariate feature vectors comprises a corresponding plurality of values of a plurality of features;
(B) producing a plurality of clusters based on the multivariate feature data; and
(C) assigning, for each the multivariate feature vectors V and for each of the plurality of clusters C, a probability that vector V is within cluster C,
wherein the assigning comprises assigning, to each of the plurality of clusters, a corresponding skew to account for skew in the plurality of multivariate feature vectors.
